(19) United States
(12) Patent Application Publication
(10) Pub. No.: US 2008/0280083 A1
(43) Pub. Date: Nov. 13, 2008

(54) HOUSING FOR AN ELECTRONIC DEVICE AND METHOD OF MAKING THE SAME

(75) Inventors: JIN-LIN QIU, Shenzhen (CN); JIE TANG, Shenzhen (CN); WU-BING LI, Shenzhen (CN); SONG ZHANG, Shenzhen (CN); CHUN-BAO WANG, Shenzhen (CN); XIONG-BO FU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); Sutech Trading Limited, Tortola (VG)

(21) Appl. No.: 11/946,300

(22) Filed: Nov. 28, 2007

(30) Foreign Application Priority Data
May 9, 2007 (CN) 200710074345.1

(51) Int. Cl. B32B 1/02; C25D 5/34

(52) U.S. Cl. 428/35.8; 205/206; 428/34.1

(57) ABSTRACT

A housing (10) is applied to an electronic device. The housing includes a transparent base (12) and a first metal coating (14). The base contains a first surface (122). The first metal coating is formed on the first surface of the base. A plurality of first through holes (142) is defined in the metal coating. The first through holes are in an arrayed pattern.

### BACKGROUND OF THE INVENTION

1. Field of the Invention

The present invention generally relates to housings, and more specifically to a housing for an electronic device and a method of making the same.

2. Description of Related Art

With the development of wireless communication and information processing technologies, portable electronic devices, such as mobile telephones and personal digital assistants (PDAs), are now in widespread use. Since the electronic devices are being used as an everyday item, the appearance of the electronic device can play an important role of its appeal. In order to improve the appearance of the electronic device, manufacturers pay more and more attention to design the housing of the electronic device. A typical housing for an electronic device has a plurality of through holes defined in a front board thereof. The through holes are in an arrayed pattern (e.g., landscape, portrait, and so on). During use, the electronic device generates light from inside. The light escapes from the through holes of the housing, so as to brightly show the pattern which the through holes arrayed. Although this housing may improve the appearance of the electronic device, dust and water could easily get into the electronic device via the through holes. In addition, since the through holes are defined in the housing, the strength of the housing is reduced. Thus, the housing may easily be deformed.

Therefore, a new housing for an electronic device is desired in order to overcome the above-described problems.

### SUMMARY OF THE INVENTION

In one embodiment thereof, a housing is applied to an electronic device. The housing includes a transparent base and a first metal coating. The base has a first surface and the first metal coating is formed on the first surface of the base. A plurality of first through holes is defined in the metal coating. The first through holes are in an arrayed pattern.

Other advantages and novel features will become more apparent from the following detailed description when taken in conjunction with the accompanying drawings.

### BRIEF DESCRIPTION OF THE DRAWINGS

Many aspects of the housing for an electronic device can be better understood with reference to the following drawings. The components in the drawings are not necessarily drawn to scale, the emphasis instead being placed upon clearly illustrating the principles of the present housing. Moreover, in the drawings, like reference numerals designate corresponding parts throughout the several views.

FIG. 1 is an isometric view of a housing, in accordance with a first embodiment of the present housing;

FIG. 2 is a cross-sectional view taken along line II-II of FIG. 1;

FIG. 3 is a cross-sectional view of a housing, in accordance with a second embodiment of the present housing;

FIG. 4 is a cross-sectional view of a housing, in accordance with a third embodiment of the present housing; and

FIG. 5 is a cross-sectional view of a housing, in accordance with a fourth embodiment of the present housing.

### DETAILED DESCRIPTION OF THE INVENTION

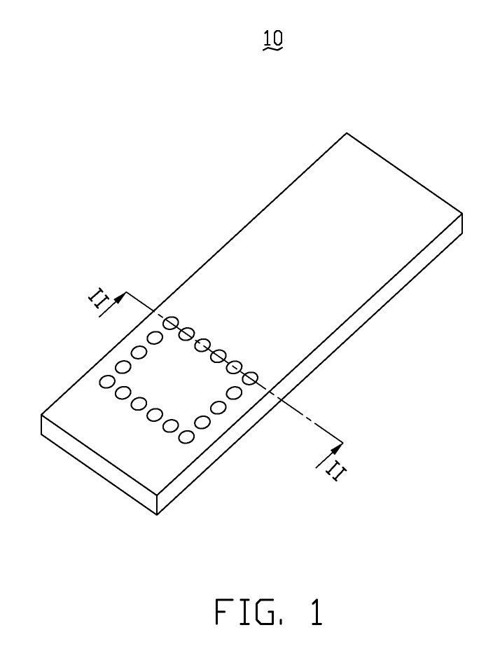

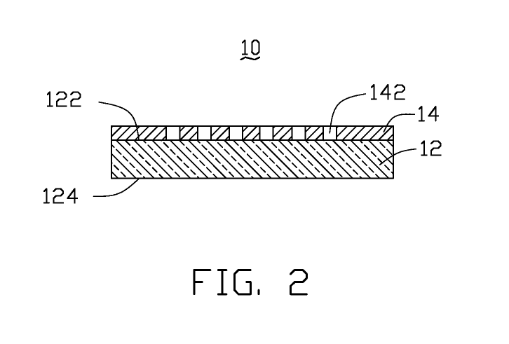

Referring now to FIGS. 1 and 2, a housing 10 for an electronic device (not shown) includes a base 12 and a metal coating 14 in accordance with a first embodiment of the present housing. The base 12 is generally a flat board and could be made from transparent plastic material. The base 12 contains a first surface 122 and an opposite second surface 124. The metal coating 14 is formed on the first surface 122 of the base 12. A number of circular through holes 142 are defined in the metal coating 14, thus the first surface 122 is exposed to the air via the through holes 142. The through holes 142 are in arrayed pattern (e.g., landscape, portrait, and so on). During the working state, the electronic device generates light from inside and the light escapes from the through holes 142 of the housing 10, so as to display the pattern brightly.

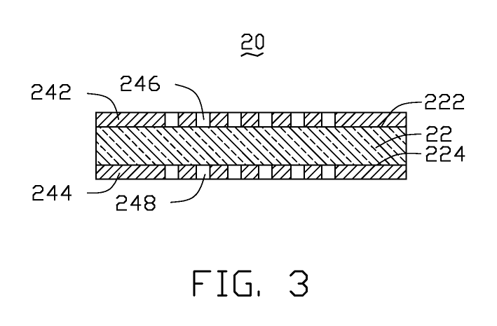

In a second embodiment, referring to FIG. 3, a housing 20 for an electronic device includes a base 22, a first metal coating 242 and a second metal coating 244 respectively coated on opposite sides of the base 22. The base 22 contains a first surface 222 and a second surface 224. The first metal coating 242 is formed on the first surface 222 of the base 22, and the second metal coating 244 is formed on the second surface 224 of the base 22. A plurality of first through holes 246 is defined in the first metal coating 242, and a plurality of second through holes 248 is defined in the second metal coating 244. The position of the first through holes 246 corresponds to the position of the second through holes 248. Each first through hole 246 should be coaxial with a corresponding second through hole 248, so that light can efficiently pass the through holes 246 and 248.

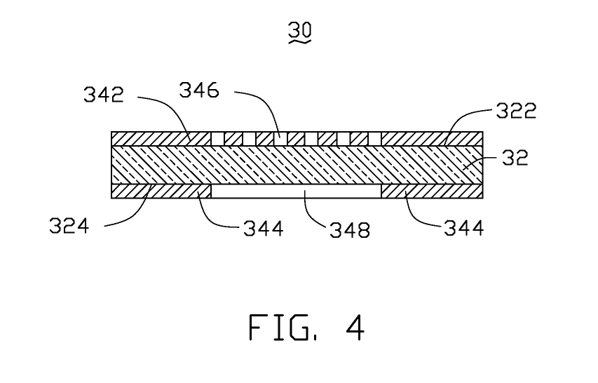

In a third embodiment, referring to FIG. 4, a housing 30 for an electronic device includes a base 32, a first metal coating 342 and a second metal coating 344. The base 32 contains a first surface 322 and a second surface 324. The first metal coating 342 is formed on the first surface 322 of the base 32, and the second metal coating 344 is formed on the second surface 324 of the base 32. A plurality of through holes 346 is defined in the first metal coating 342. The second metal coating 344 has an opening 348 defined therein. The area of the opening 348 covers the vertical projected area of the through holes 346, so that light can pass through the opening 348 of the second metal coating 344 and the through holes 346 of the first metal coating 342.

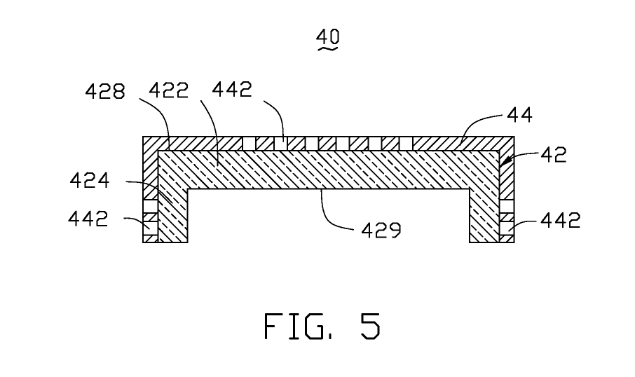

In a fourth embodiment, referring to FIG. 5, a housing 40 for an electronic device includes a base 42 and a metal coating 44. The base 42 has a plate 422 and two sidewalls 424 respectively protruding from two sides of the plate 422. The metal coating 44 covers the plate 422 and the two sidewalls 424. A plurality of through holes 442 is formed in the metal coating 44. The through holes 442 are arranged in an arrayed pattern.

A method for making the housing 20 according to a second embodiment of the present invention, includes a series of steps, as follows.

Firstly, the base 22 is formed by a plastic injection molding machine. The base 22 is made of transparent plastic material, such as polycarbonate. The base 22 contains the first surface 222 and the second surface 224.

Secondly, the base 22 is plated so as to form the first metal coating 242 and the second metal coating 244. The first metal coating is formed on the first surface 222 of the base 22, and the second metal coating is formed on the second surface 224. The method of plating the base 22 includes the steps as follow:

using alkaline solution, such as sodium hydroxide or sodium carbonate to clean the surface of the base 22, so as to get rid of the oil or impurity on the surface of the base 22;

using vitriol solution and chromium solution to perform roughness elimination treatment on the surface of the base 22 at temperature 60˜80° C. for 2˜10 minutes, so that granules can be attached to the surface of the base 22;

rinsing out the leaving solution and chromium solution from the base 22 with soft water;

immersing the base 22 into a alkaline solution, such as sodium hydroxide, at temperature 40˜55° C. for 3˜10 minutes, so as to counteract the acid leaving in the base 22;

immersing the base 22 into a solution with sensitizer so as to add readily oxidizable materials onto the surface of the base 22;

immersing the base 22 into a palladium stannum alloy solution at temperature 40˜50° C. for 2˜8 minutes, so as to form a layer of palladium Stannum alloy on the surface of the base 22;

immersing the base 22 into a sodium hydroxide solution for 2˜6 minutes so as to remove the stannum ions from the layer on the base 22, thus remaining palladium ions arrayed on the base 22;

immersing the base 22 into a nickel solution at temperature 35˜45° C. for 2˜8 minutes so as to form a palladium nickel layer on the surface of the base 22, wherein the nickel solution includes nickel vitriol, sodium hydrosulfite and ammonium chloride;

rinsing out the leaving nickel solution on the base 22 with soft water;

plating the base 22 in a nickel electrolyte so as to form the first metal coating 242 and the second metal coating 244, wherein the base 22 is connected with a cathode pole, a nickel post is inserted into the nickel electrolyte and is connected with an anode pole so as to apply nickel ions, and the first metal coating 242 and the second metal coating 244 are 0.05˜0.08 μm thickness.

Thirdly, using a laser engraving machine to carve the first metal coating 242 and the second metal coating 244 so as to form a plurality of first through holes 246 in the first metal coating 242 and a plurality of second through holes 248 in the second metal coating 244, wherein the through holes 246 of the first metal coating 242 are coaxial with a corresponding through hole 248 of the second metal coating 244, and the base 22 is exposed to the air via the through holes 246, 248.

At last, plating the base 22 in a nickel electrolyte again so as to increase the thickness of the metal coatings, wherein the metal coatings are connected with a cathode pole, a nickel post is inserted into the nickel electrolyte and is connected with an anode pole so as to apply nickel ions. Since the base 22 is not electric during this plating treatment, a metal layer does not coat the exposed areas of the base 22. Thus, the housing 20 is formed.

It should be understood that since the base does not have holes defined therein, the strength of the base does not reduced.

It also should be understood that the surface of the base 22 might be coated by a copper layer or a chrome layer.

It also should be understood that the last step may be omitted if the appearance of the electronic is in lower requirement.

It also should be understood that the method may be applied to mobile phones, note books, game machines and so on.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing for an electronic device, comprising:
a transparent base having a first surface;
a first metal coating being formed on the first surface of the transparent base, a plurality of first through holes being defined in the first metal coating, the first through holes being formed and arranged in an arrayed pattern.

2. The housing as claimed in claim 1, further comprising a second metal coating, wherein the base further includes a second surface opposite to the first surface, the second metal coating is formed on the second surface of the base, a plurality of second through holes are defined in the second metal coating, and each of the second through holes respectively corresponds to one of the first through holes.

3. The housing as claimed in claim 2, wherein each first through hole is coaxial with a corresponding second through hole.

4. The housing as claimed in claim 1, wherein the base further includes a second surface opposite to the first surface, a second coating is formed on the second surface of the base, an opening is defined in the second metal coating, and the area of the opening covers the vertical projected area of the first through holes.

5. The housing as claimed in claim 1, wherein the base is made of plastic material.

6. The housing as claimed in claim 1, wherein each first through hole is circular.

7. A method for making a housing for an electronic device, comprising steps of:
forming a transparent base, the base having a first surface;
forming a first metal coating on the first surface of the base; and
forming a plurality of first through holes in the in the first metal coating, the first through holes being arranged in an arrayed pattern.

8. The method as claimed in claim 7, wherein the first metal coating is formed on the first surface of the base by plating.

9. The method as claimed in claim 8, wherein the step of plating the base with the first metal coating comprises steps of:
performing roughness treatment on the surface of the base;
rinsing out the base with soft water;
adding readily oxidizable materials onto the surface of the base;
forming a layer of palladium Stannum alloy on the surface of the base;
removing the stannum from the layer on the base;
immersing the base into a nickel solution so as to form a palladium nickel layer on the surface of the base;
rinsing out the leaving nickel solution on the base with soft water; and plating the base in a nickel electrolyte so as to form the first metal coating.

10. The method as claimed in claim 9, wherein the base is cleaned using alkaline solution before roughness treatment.

11. The method as claimed in claim 9, wherein vitriol solution and chromium solution are used to perform roughness treatment on the surface of the base.

12. The method as claimed in claim 11, wherein the method of plating the base further comprises a step of using alkaline solution to counteract the acid leaving in the housing before adding readily oxidizable materials onto the surface of the base.

13. The method as claimed in claim 7, further comprising a step of plating the housing in a nickel electrolyte again after the metal coating being defined the first through holes.

14. The method as claimed in claim 9, wherein the through holes are formed by a laser engraving machine.

15. The method as claimed in claim 9, wherein the base is made of plastic material.
